(19) United States
(12) Patent Application Publication
(10) Pub. No.: US 2009/0108205 A1
(43) Pub. Date: Apr. 30, 2009

(54) NIRS SENSOR MOUNTING APPARATUS

(75) Inventors: Karen Duffy, Orange, CT (US); Paul Benni, Guilford, CT (US); George Brocksieper, Guilford, CT (US)

Correspondence Address: O''Shea Getz P.C., 1500 MAIN ST. SUITE 912, SPRINGFIELD, MA, 01115, US

(73) Assignee: CAS Medical Systems, Inc., Branford, CT (US)

(21) Appl. No.: 12/248,556

(22) Filed: Oct. 9, 2008

Related U.S. Application Data
(60) Provisional application No. 60/978,935, filed on Oct. 10, 2007.
(60) Provisional application No. 60/978,929, filed on Oct. 10, 2007.
(60) Provisional application No. 61/023,662, filed on Jan. 25, 2008.

(51) Int. Cl. G01J 5/02

(52) U.S. Cl. 250/339.07

(57) ABSTRACT

A near infrared spectrophotometric (NIRS) sensor apparatus is provided that includes at least one NIRS sensor and a mounting device. The sensor has at least one light source, at least one light detector, and a flexible pad. The light source and the light detector are mounted on the flexible pad, which flexible pad has a peripheral edge that extends around the entire periphery of the pad. The light source and light detectors are configured for connection to an electro-optical cable. The mounting device is operable to secure the sensor to a subject, which mounting device is sized to cover the sensor and contact the subject around the entire peripheral edge of the pad. The mounting device includes a light barrier that at least substantially blocks light from passing through the mounting device.

Applicant hereby claims priority benefits under 35 U.S.C. § 119(e) of U.S. Provisional Patent Application No. 60/978,935 filed Oct. 10, 2007, U.S. Provisional Patent Application No. 60/978,929 filed Oct. 10, 2007 and U.S. Provisional Patent Application No. 61/023,662 filed Jan. 25, 2008, the disclosures of which are herein incorporated by reference.

### BACKGROUND OF THE INVENTION

1. Technical Field

This invention relates to methods and apparatus for non-invasively determining biological tissue oxygenation utilizing near-infrared spectroscopy (NIRS) techniques in general, and to sensors and sensor mounting devices for use with such techniques in particular.

2. Background Information

Near-infrared spectroscopy is an optical spectrophotometric method that can be used to continuously monitor tissue oxygenation. The NIRS method is based on the principle that light in the near-infrared range (700 nm to 1,000 nm) can pass easily through skin, bone and other tissues where it encounters hemoglobin located mainly within micro-circulation passages; e.g., capillaries, arterioles, and venuoles. Hemoglobin exposed to light in the near-infrared range has specific absorption spectra that varies depending on its oxidation state; i.e., oxyhemoglobin (HbO₂) and deoxyhemoglobin (Hb) each act as a distinct chromophore. By using light sources that transmit near-infrared light at specific different wavelengths, and measuring changes in transmitted or reflected light attenuation, concentration changes of the oxyhemoglobin (HbO₂) and deoxyhemoglobin (Hb) can be monitored. The ability to continually monitor cerebral oxygenation levels, for example, is particularly valuable for those patients subject to a condition in which oxygenation levels in the brain may be compromised, leading to brain damage or death.

NIRS type sensors typically include at least one light source and one or more light detectors for detecting reflected or transmitted light. The light signal is created and sensed in cooperation with a NIRS system that includes a processor and an algorithm for processing signals and the data contained therein. U.S. Pat. No. 7,047,054, which is commonly assigned with the present application to CAS Medical Systems, Inc. of Branford, Conn., discloses an example of such a sensor. Light sources such as light emitting diodes (LEDs) or laser diodes that produce light emissions in the wavelength range of 700-1000 nm are typically used. A photodiode or other light detector is used to detect light reflected from or passed through the tissue being examined. The NIRS system cooperates with the light source(s) and the light detectors to create, detect, and analyze the signals in terms of their intensity and wave properties. U.S. Pat. Nos. 6,456,862, and 7,072,701, both of which are commonly assigned to CAS Medical Systems, Inc., of Branford, Conn., disclose a methodology for analyzing such signals. U.S. Pat. Nos. 6,456,862, 7,047,054, and 7,072,701 are hereby incorporated by reference in their entirety.

It is known to attach a NIRS sensor to a patient's skin by adhesive applied to a surface of the sensor's pad. An advantage of securing a sensor in this manner is that the sensor can be specifically located by the technician, and in most instances will stay attached for as long as the sensor is needed.

A disadvantage of many sensors attached by adhesive is that the adhesive can damage the patient's skin. Patients having very thin or delicate skin are susceptible to the skin damage (e.g., tearing) when the sensor is removed, or even if lateral force is applied to the sensor. Neonates, for example, often have delicate skin that can be easily damaged by adhesive sensors. This is particularly true for premature neonates. Other patients with delicate skin include the elderly, burn victims, or patients having skin compromised by disease.

Another issue that arises with NIRS sensors having an adhesive pad that is intended to be stuck to the subject's skin is that the pads typically are only big enough to surround the light source and light detector(s). Infant skin is often more conductive than adult skin. As a result, a sensor pad sized to avoid interference from ambient light entering around the periphery of the sensor of an adult, may not be sufficiently sized for an infant. In addition, certain pad adhesives can function as a light shunt, allowing peripheral ambient light to travel within the adhesive layer between the pad and the subject and thereby introduce undesirable error into the sensing.

There are advantages to using a sensor having a light source that utilizes one or more fiber optic light guides in communication with remotely located laser diodes, rather than an electrical light source (e.g., LED's) located directly within the sensor body. Fiber optic light guides, however, have operational requirements. A principal requirement is that the fiber optic light guide not be bent sharper than a minimum turn radius. Bending a fiber optic light guide into a turn that is sharper than a minimum accepted radius for that particular light guide can result in undesirable losses within the light signal.

What is needed, therefore, is a NIRS sensor that can be readily and securely applied to a patient, one that enables the sensor to be easily located, one that can be used and removed without damaging the skin of the patient, and one with a cable that can provide electrical power and receive electrical signals, and which includes one or more fiber optic strands that are operable to act as a light guide.

### DISCLOSURE OF THE INVENTION

According to the present invention, a near infrared spectrophotometric (NIRS) sensor apparatus is provided that includes at least one NIRS sensor and a mounting device. The sensor has at least one light source, at least one light detector, and a flexible pad. The light source and the light detector are mounted on the flexible pad, which flexible pad has a peripheral edge that extends around the entire periphery of the pad. The light source and light detectors are configured for connection to an electro-optical cable. The mounting device is operable to secure the sensor to a subject, which mounting device is sized to cover the sensor and contact the subject around the entire peripheral edge of the pad. The mounting device includes a light barrier that at least substantially blocks light from passing through the mounting device.

One of the advantages of the present invention sensor apparatus is that it provides a NIRS sensor that in many instances can be attached to a patient's skin without damaging the patient's skin. Embodiments of the present invention avoid using adhesive altogether. Other embodiments utilize little adhesive, and the adhesive that is used is of a type that is not apt to damage a patient's skin.

Another advantage of the present invention sensor apparatus is that it helps to maintain the sensor in a desired location. The sensor mounting device can mount the sensor(s) to the patient's head or other body region and securely maintain it there, in many instances without adhesive.

Another advantage of the present invention is that the sensor mounting device can be used to block ambient light from accessing the sensor and thereby interfering with the functioning of the sensor. For example, the sensor mounting device can be made of, or include, a light blocking material that is disposed completely over the sensor, and around the periphery of the sensor when applied to the patient. As a result, the detector(s) within the sensor is less likely to detect ambient light and the error associated therewith.

Another advantage of the present invention is that the sensor(s) can be mounted on the patient by the sensor mounting device without the use of adhesive on the surface of the sensor. It is our experience that certain adhesives can function as a light shunt, allowing light to travel within the adhesive layer from the light source to the light detector. Such a light path does not travel through the patient and therefore introduces undesirable error into the sensing. The absence of an adhesive layer in contact with the operative side of the sensor in the present invention avoids undesirable shunting.

According to an aspect of the present invention, an electro-optical cable is provided that includes at least one fiber optic light guide and at least one electrical cable disposed within an exterior sheath. In preferred embodiments, the cable has a configuration that helps to prevent the cable from being bent at an angle less than the minimum bend radius of one or more fiber optic strands disposed within the fiber optic light guide. In embodiments having more than one electrical cable, the cable can be configured with the fiber optic light guide disposed between, and therefore separating, the two electrical cables. In such configurations, the separation between the electrical cables decreases the potential for electromagnetic interference (EMI) between the electrical cables. At the same time, the electrical cables (or cable and structural feature) provide support and a predetermined amount of stiffness for the cable.

The foregoing features and advantages of the present invention will become more apparent in light of the following detailed description of exemplary embodiments thereof.

### BRIEF DESCRIPTION OF THE DRAWINGS

FIG. 1 is an exploded diagrammatic view of a sensor that may be used with the present invention NIRS sensor apparatus.

FIG. 2 is a diagrammatic planar view of an embodiment of the present invention NIRS sensor apparatus, showing the patient side surface.

FIG. 3 is a diagrammatic planar view of an embodiment of the present invention NIRS sensor apparatus, showing the outside surface.

FIG. 4 is a diagrammatic side view of the present invention NIRS sensor apparatus mounted on a patient's head.

FIG. 5 is a diagrammatic back view of the present invention NIRS sensor apparatus mounted on a patient's head.

FIG. 6 is a diagrammatic planar view of an embodiment of the present invention NIRS sensor apparatus, showing the patient side surface.

FIG. 7 is a diagrammatic perspective view of an embodiment of the present invention NIRS sensor apparatus.

FIG. 8 is a diagrammatic side view of the present invention NIRS sensor apparatus mounted on a patient's head.

FIG. 9 is a diagrammatic view of the present invention NIRS sensor apparatus mounted on a patient's abdomen.

FIG. 10 is a diagrammatic view of the present NIRS sensor apparatus showing an embodiment of the mounting device.

FIG. 11 shows the mounting device embodiment shown in FIG. 10 with a tensioning tab attached.

FIG. 12 is a diagrammatic view of the present NIRS sensor apparatus showing an embodiment of the mounting device, including an integral cap portion.

FIG. 13 is a diagrammatic view of the present NIRS sensor apparatus showing an embodiment of the mounting device, including an attached cap portion.

FIG. 14 is a diagrammatic view of the gel patch.

FIG. 15 is a diagrammatic view of the present NIRS sensor apparatus showing an embodiment of the mounting device.

FIG. 16 is a cross-sectional view of a segment of a linear embodiment of the present invention electro-optical cable.

FIG. 17 is a cross-sectional view of a segment of an L-shaped embodiment of the present invention electro-optical cable.

FIG. 18 is a cross-sectional view of a segment of an X-shaped embodiment of the present invention electro-optical cable.

FIG. 19 is a cross-sectional view of a segment of a linear embodiment of the present invention electro-optical cable.

### DETAILED DESCRIPTION THE INVENTION

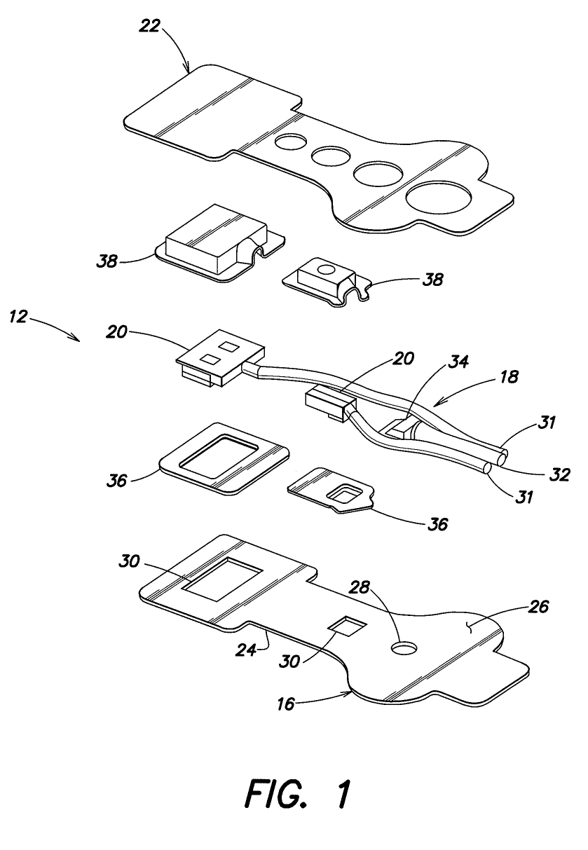

Now referring to FIGS. 1-19, the present invention NIRS sensor apparatus 10 includes at least one NIRS sensor 12 and a mounting device for mounting the sensor 12 on a patient. The NIRS sensor 12 is adapted for use with a NIRS system that includes a processor for providing signals to and/or receiving signals from the NIRS sensor 12. For purposes of providing a detailed description of the present NIRS sensor 12, the sensor 12 will be described herein as being used in connection with the NIRS system described in U.S. Pat. No. 6,456,862 and U.S. Pat. No. 7,071,701, which are examples of acceptable NIRS systems. The NIRS sensor 12 is not, however, limited to use with any particular NIRS system.

### NIRS Sensor:

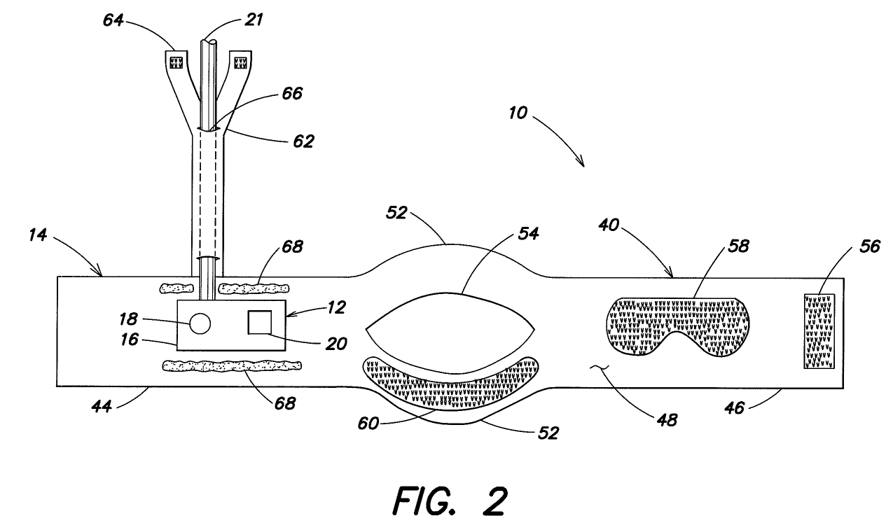

Now referring to FIG. 1, an example of an acceptable NIRS sensor 12 is described in U.S. Provisional Patent Application Ser. No. 60/868,635, filed on Dec. 5, 2006, and U.S. Provisional Patent Application Ser. No. 61/023,662, filed on Jan. 25, 2008, and is hereby incorporated by reference. The aforesaid NIRS sensor 12 includes a flexible pad 16, light source 18, a light detector 20, a cable 21, and a cover 22. The NIRS sensor 12 embodiment shown in FIG. 1 includes a pair of light detectors 20. Other embodiments (e.g., see FIG. 2) may include only one light detector 20, or more than two light detectors 20.

The flexible pad 16 has a width and length, a substantially uniform thickness, a patient side surface 24, a hardware side surface 26, at least one light source aperture 28, and at least one light detector aperture 30. The aforesaid apertures 28, 30 are aligned along a center line of the pad 16. The pad 16 is preferably made from a material (e.g., foam) that substantially or completely blocks the transmission of light energy through the pad 16. Poron® cellular urethane foam, a product of Rogers Corporation of Woodstock, Conn. USA, is an example of an acceptable pad material. In a preferred embodiment, a film is attached to the patient side surface 24 of the flexible pad, which film complies with ISO Standard 10993-1 for Biocompatibility. An example of an acceptable film is a polyurethane film (e.g., 3M polyurethane film no. 9833). The film is non-sticky and permits easy removal and repositioning of the sensor. In some embodiments, the patient side surface of the pad, or a film attached thereto, may include a low-adhesion type of adhesive that helps to maintain the position of the sensor on the patient's skin once attached. The adhesive preferably is of a type that allows the sensor to be removed from and reapplied to the patient without an appreciable loss of adhesion. Examples of acceptable adhesives include any of silicone, hydrogel, and karaya type adhesive systems. In preferred embodiments, a hydrogel adhesive is used that is a tacky, cross-linked, polymeric mixture, that may be, but is not necessarily, electrically conductive, one that satisfies the relevant biocompatibility standards, and one that is mechanically stable in high humidity environments.

The light source 18 is selectively operable to guide or emit infrared light. The light source 18 is an assembly that includes at least one fiber optic light guide 32 and a light redirecting prism 34. One end of the fiber optic light guide 32 is optically connected to the light redirecting prism 34. The other end of the fiber optic light guide 32 is typically disposed within a connector (e.g., an SC-type connector, having a push-pull latching mechanism that ensures a positive attachment to another optical fiber) that permits the fiber optic light guide 32 to be optically coupled to a light guide connected to the NIRS system. The fiber optic light guide 32 typically includes one or more fiber optic strands through which light passes. Optical fiber strands are typically made from a glass or a plastic material designed to guide light lengthwise along the fiber optic strand. In some embodiments, the light source 18 may have a section of fiber optic light guide 32 designed for connection to a selectively attachable/detachable cable 21, which cable 21 includes a light guide for connection to hardware operable to receive and interpret light signals (i.e., the NIRS system). In other embodiments, a fiber optic light guide 32 disposed within cable 21 is directly attached to the prism 34.

In those embodiments that utilize a fiber optic light guide 32, the light source 18 may not create a light signal itself. Rather, light signals may be introduced into the fiber optic light guide 32 at a position external of the NIRS sensor 12 and are then guided into the sensor 12 via the fiber optic light guide 32. In alternative embodiments, a light emitting diode (LED) can be used as a light source 18.

The light detector(s) 20 of the NIRS sensor 12 each includes a light responsive transducer such as a photodiode that is operative to sense light intensity derived from light emitted by the light source 18 after such light passes through the patient's body. Each light detector 20 is electrically connected to a shielded cable 31 that in turn connects the light detector 20 to the NIRS system. The light detector 20 may be partially enclosed by a copper foil tape and/or may have a copper mesh disposed over the receiving surface of the photodiode. The copper mesh is electrically connected to a ground. The aforesaid shielding arrangements represent examples of acceptable EMI shielding arrangements, and the present invention is not limited thereto.

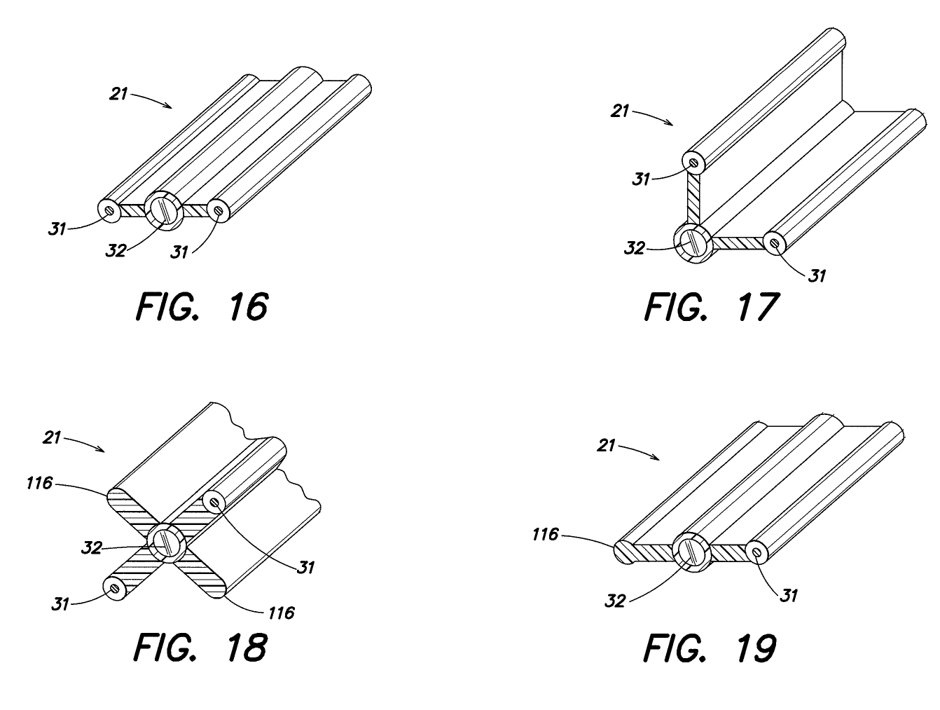

In preferred embodiments, the cable 21 (see FIGS. 16-19) includes at least one fiber optic light guide 32 and at least one electrical cable 31 disposed within an exterior sheath. The electrical cable 31 provides a passage for electrical signals between the sensor 12 and a processor. In some embodiments, the shielded electrical cables may be “co-ax” type cables that have a metallic mesh sleeve peripherally surrounding one or more electrical conductors. The electrical conductors are mutually insulated from one another. The metallic mesh sleeve is preferably disposed inside a generally tubular, rubber-like outer sleeve, which is preferably of an electrically insulating material. The metallic mesh sleeve is operable to be placed in electrical contact with an outer shielding layer of an electrical component board. The electrical cable(s) 31 and fiber optic light guide 32 are preferably sheathed within a flexible outer sheath comprising a material such as a flexible rubber or plastic compound.

The significance of minimizing electromagnetic interference within the electrical cables is particularly important in applications where the electrical signals transmitted through the cables 31 are very small in magnitude. Similarly, the significance of minimizing attenuation within the fiber optic light guide 32 is also particularly important in applications (e.g., NIRS) where signal data integrity depends heavily of the consistency of the light signal magnitude passing through the one or more fiber optic strands. To those ends, the electrical cable 31 and the fiber optic light guide 32 can be relatively positioned within the cable 21 in geometric configurations that help avoid the undesirable interference and attenuation. For example, with respect to cables 21 having more than one electrical cable 31, the most desirable configurations are those wherein the fiber optic light guide 32 is disposed between and therefore separates the two electrical cables 31. In such configurations, the separation between the electrical cables 31 decreases the potential for electromagnetic interference (EMI) between the electrical cables 31. At the same time, the electrical cables 31 provide support and a predetermined amount of stiffness for the cable 21. As a result, the fiber optic light guide 32 is less susceptible to being bent in an angle less than the minimum bend radius of the one or more fiber optic strands disposed within the fiber optic light guide 32. In some embodiments, additional structural features 116 are added to the electro-optical cable 21 to provide additional strength, stiffness, and resistance to sharp bends. Examples of acceptable geometric configurations include: 1) a linear arrangement as shown in FIG. 16, wherein the electrical cables 31 are disposed on opposite sides of the fiber optic light guide 32; 2) an “L” shaped configuration as shown in FIG. 17, wherein the fiber optic light guide 32 is disposed at the corner of the “L”, and the electrical cables 31 are disposed at the ends of the “L”; 3) an “X” (or “+”) shaped configuration as shown in FIG. 18, wherein the fiber optic light guide 32 is disposed at the center of the “X” and the electrical cables 31 are disposed at the end of opposing legs of the “X”; and 4) a linear arrangement as shown in FIG. 19, wherein an electrical cable 31 is disposed on one side of the light guide 32 and a structural feature similar in shape to that of the electrical cable 31 is disposed on the opposite side of the fiber optic light guide 32. A triangular geometric configuration may also be used in some applications.

The electro-optical cable 21 preferably has a constant cross-sectional geometry that permits the electrical cables 31 and the fiber optic light guides 32 to be relatively positioned and joined with the flexible outer sheath in an extrusion process. The electro-optical cable 21 is not, however, limited to formation by extrusion.

The light detector(s) 20 may be mounted within the NIRS sensor 12 in a variety of different ways. In the sensor embodiment shown in FIG. 1, for example, the light detectors 20 are each disposed within a housing that includes a base 36 and a cap 38. The base 36 includes a well sized to receive at least a portion of the light detector 20, and the cap 38 is sized to receive a remainder of the light detector 20 not received within the base well. The base 36 has a bottom panel referred to as a window, which window consists of optically transmissive material that allows light to pass therethrough and be sensed by the light detectors 20. The base 36 and cap 38 combine to form an internal cavity that is sized so that a light detector 20 partially or completely covered with shielding fits snugly within the internal cavity and is not likely to positionally shift within the housing. The well of the housing is received within the aperture of the flexible pad 16.

The cover 22 preferably consists of a soft pliable material that can be used in a patient environment. Examples of acceptable cover materials include, but are not limited to, vinyl materials, plastic materials and foam materials (e.g., Poron(®). The cover 22 may be attached to the NIRS sensor 12 in a variety of different ways; e.g., the cover 22 may be adhered to the pad 16. The cover material preferably blocks light from entering the NIRS sensor 12.

The present invention NIRS sensor apparatus 10 can be used with a variety of different NIRS sensors 12 and is not, therefore, limited to any particular type of NIRS sensor.

### NIRS Sensor Mounting Device—Head Embodiments:

Now referring to FIGS. 1, 2-5, and 8, a first embodiment of the mounting device 14 is operable to mount one or more sensors 12 on the head of a patient. In this embodiment, the mounting device 14 includes a strap 40 having length extending between a first end 44 and a second end 46, and having a patient side surface 48 and an outside surface 50. The strap 40 includes a pair of midsection segments 52 extending between the first end 44 and the second end 46. The midsection segments 52 diverge from one another and subsequently converge back together, thereby creating an opening 54 therebetween. In some embodiments, one or more tabs 55 may be attached to the outside surface 50 of the midsection segments 52 to facilitate moving the mounting device 14 when mounted on a patient. The geometry of the opening 54 between the midsection segments 52, and the resultant spacing of the midsection segments 52 facilitates positioning of the mounting device 14 on the patient's head as will be described below. The ends 44, 46 of the strap 40 include a means 56 for attaching to one another such as mating fastener pairs (hook and loop, male and female snaps, etc.), adhesive, or the like.

In the embodiment shown in FIG. 2, the sensor 12 is attached to the patient side surface 48 of the first end 44. In other embodiments, a plurality of sensors 12 may be attached to the patient side surface 48 at various different positions to coincide with desired regions of the patient; e.g., left and right sensors 12 located to coincide with the patient's temporal regions, or each side of the head, or right and left sides of the base of the skull, etc. The sensor(s) 12 may be attached to the patient side surface 48 by fastener (e.g., hook and loop fasteners, snaps, etc.) or adhesive, or it may be disposed within a pocket attached to the patient side surface 48, or the like. The method of attachment may be intended to be permanent (e.g., if the entire NIRS sensor apparatus 10 is disposable) or it may be a readily removable type attachment that permits the sensor(s) 12 to be readily detached from the mounting device 14 (e.g., if just the mounting device 14 is disposable).

In the embodiment shown in FIG. 2, a light blocking patch 58 is attached to the patient side surface 48 of the second end 46. The light blocking patch 58 may be any material or surface treatment attached to a surface of the mounting device 14 that helps to shield ambient light and thereby avoid ambient light interference. In neonatal applications where a jaundice condition may require phototherapy, the light blocking patch 58 can be sized and located to also protect the neonate's eyes. In the embodiment shown in FIG. 2, the light blocking patch 58 is positioned so that when the second end 46 of the strap 40 is wrapped over the first end 44, the light blocking patch 58 covers the NIRS sensor 12 attached to the first end 44 of the strap 40. Alternatively, a light blocking patch 58 can be attached to the strap 40 in such a manner that the first and second ends 44, 46 of the strap 40 are positionable over the patient's forehead, and the light blocking patch 58 can be selectively positioned over the patient's eyes.

In some sensor mounting device embodiments, one or both of the midsection segments 52 may include padding 60 or other additional material to provide support for the strap 40 and comfort for the patient.

In some sensor mounting device 14 embodiments, the mounting device 14 includes a top member 62 attached to one of the first end 44 or second end 46 of the strap 40, extending substantially perpendicularly out from the strap 40 and terminating at a free end 64. The top member 62 shown in FIGS. 2-4 has a split free end 64. The free end 64 of the top member 62 is selectively attachable to one or both of the midsection segments 52 by fastener (e.g., hook and loop, snap, etc.), adhesive, or the like.

In some embodiments, the top member 62 may have a structure to secure the sensor cable to the top member 62. The embodiment shown in FIG. 2, for example, has a pocket 66 to receive the sensor cable 21. In these embodiments, the top member 62 helps to maintain the sensor cable 21 in a favorable location and thereby make the sensor 12 less apt to be dislodged.

The strap 40 is preferably made from a material that has some elastic capability and is therefore stretchable. The term “elastic” is used herein to mean a material that is capable of quickly or immediately returning to, or towards, its initial form or state after deformation. Examples of stretchable materials include natural and synthetic rubbers, laminates containing at least one elastomeric layer, elastomeric films, spunbond, a spunbond laminate (SBL), or other material known to those skilled in the art. SBL is a material manufactured and commercially sold by Kimberly-Clark Corporation, of Wisconsin U.S.A. Examples of stretchable materials and/or the process for making the same are disclosed in U.S. Pat. Nos. 4,720,415; 5,336,545; 5,366,793; 5,385,775 and in U.S. Patent Publication 2002/0119722A1 dated Aug. 29, 2002, all of which are incorporated by reference and made a part hereof.

In some embodiments, the strap 40 may include a water based adhesive such as hydrogel disposed in one or more locations around the patient side surface 48 of the strap 40; e.g., line segments 68 of hydrogel may be disposed on the patient side surface 48 above and below where the sensor 12 is attached. As stated above, in preferred embodiments, the hydrogel adhesive is a tacky cross-linked, polymeric mixture, that may be, but is not necessarily, electrically conductive, one that satisfies the relevant biocompatibility standards, and one that is mechanically stable in high humidity environments. The hydrogel is not relied upon to secure the strap 40 to the patient. Rather, the hydrogel impedes movement of the strap 40 relative to the patient's skin and thereby helps to maintain the strap 40 in the desired position relative to the patient.

The mounting device 14 can be mounted on the patient's head by positioning the first end 44 of the strap 40 on the patient's forehead, and wrapping the strap 40 around the patient's head so that the second end 46 overlaps the first end 44. The strap 40 is then stretched some amount and the patient side surface 48 of the second end 46 is attached to the outside surface 50 of the first end 44. The elasticity of the strap 40 helps to maintain the strap 40 in position. The midsection segments 52 are positioned so that one of the midsection segments 52 is disposed at the base of the patient's skull and the other midsection segment 52 is disposed either at the middle region or the middle-upper region of the back of the patient's skull. Together, the midsection segments 52 operate to keep the strap 40 positionally located. In those embodiments having a top member 62, the top member 62 is pulled backward from the first or second end 44, 46 to which it is attached, and secured to one or both of the midsection segments 52. The top member 62 helps to positionally maintain the strap 40, while still allowing portions of the patient's scalp to be exposed.

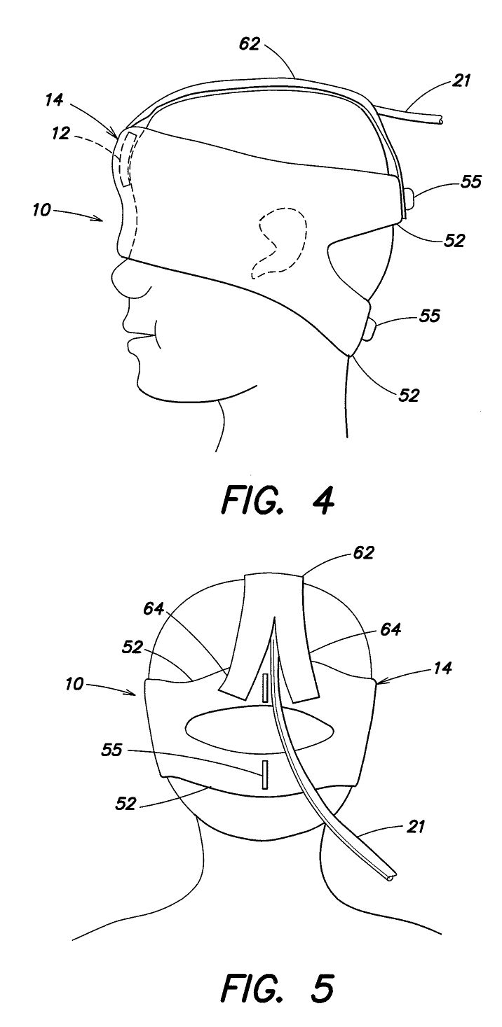

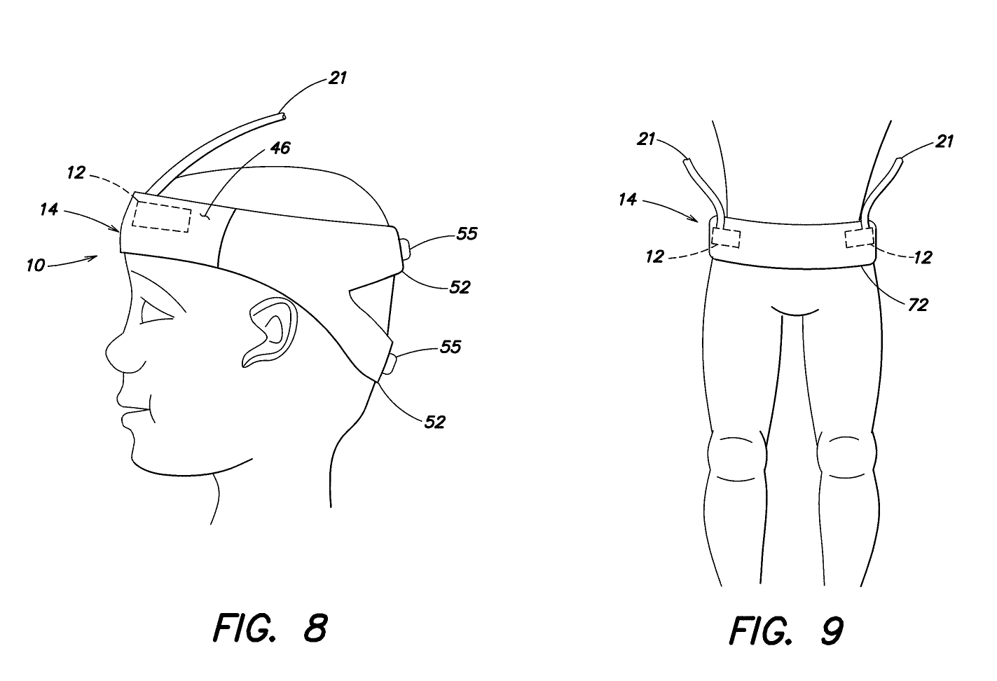

The mounting device 14 shown in FIG. 4 shows the strap 40 covering the eyes and ears of the patients. The patient's eyes and ears are not necessarily covered, and the strap 40 can be configured to avoid covering the eyes and/or ears of the patient. The mounting device 14 shown in FIG. 8, for example, is positioned such that the patient's eyes and ears are not covered.

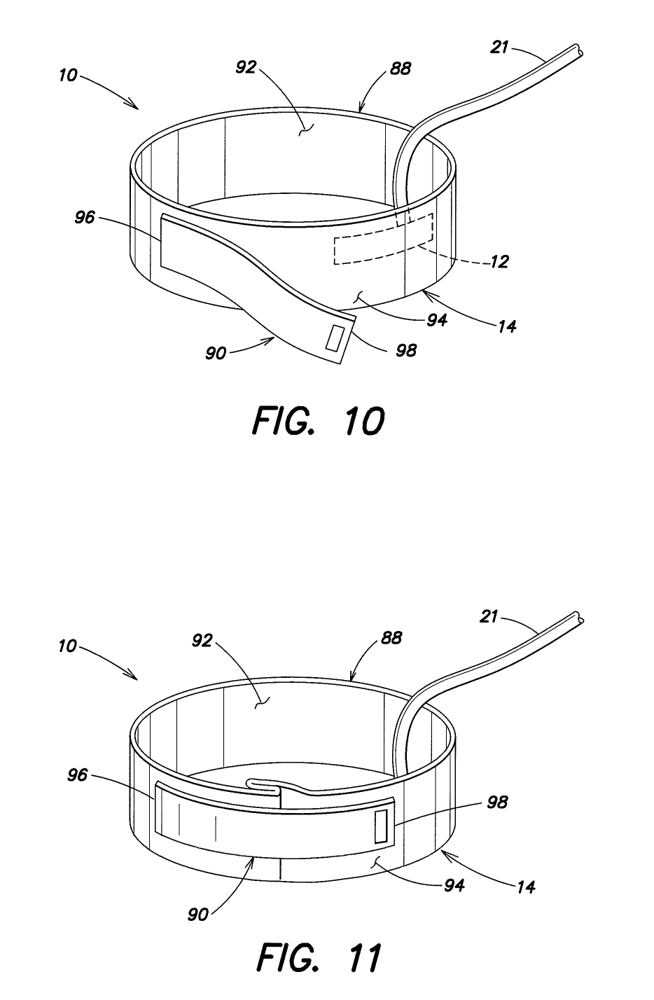

Now referring to FIGS. 10 and 11, in a further embodiment, the mounting device 14 includes a circuitous band strap 88 with a tensioning strap 90. The band strap 88 has a patient side surface 92 and an outer surface 94, and may be formed from a material that has some elastic capability (e.g., a spunbond laminate as is described above). The tensioning strap 90 may also be elastic, or the strap 90 may be elastic and the band strap may be of a material that is not chosen for purposes of acting like a band strap 88 for its elasticity. One or more sensors 12 are attached to the patient side surface 92 of the band strap 88 (or disposed within a window, etc.) at various different positions to coincide with desired regions of the patient; e.g., left and right sensors 12 located to coincide with the patient's temporal regions, or each side of the head, or right and left sides of the base of the skull, etc. The sensor(s) 12 may be attached to the band strap 88 patient side surface 92 in the manner described above. One or more light blocking patches (described above) may be attached to one or both surfaces 92, 94 of the band strap 88. The tensioning tab 90 has a first end 96 attached to the band strap 88 and a second end 98 that is selectively attachable to the band strap 88. The second end 98 may be attached to the band strap 88 by fastener (e.g., hook and loop fasteners, snaps, etc.), adhesive, or the like. The end user can adjust the fit of the mounting device 14 on the patient's head by judiciously selecting the position at which the second end 98 of the tensioning tab 90 is attached to the band strap 88. For example, the band strap 88 is preferably sized so the mounting device 14 fits easily around the patient's head (i.e., a slide-type fit). The second end 98 of the tensioning tab 90 can be attached to the band strap 88 to place the strap 88 under tension on the patient's head, thereby impeding movement of the strap 88 relative to the patient's head. FIG. 11 shows an embodiment wherein the tensioning tab 90 is attached to the band strap 88 to decrease the circumference of the band strap 88.

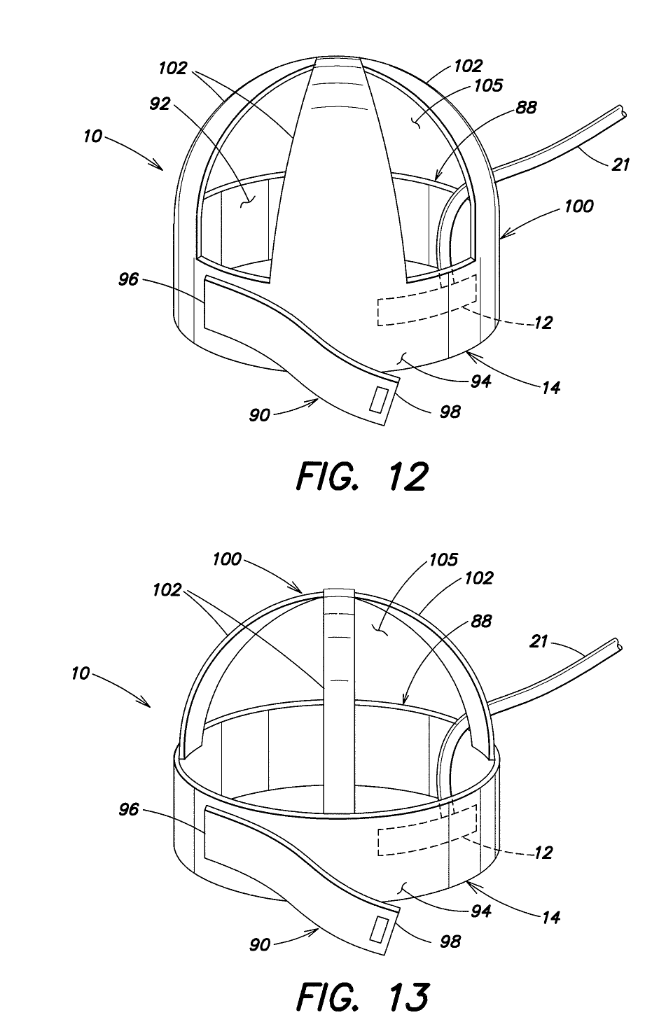

Now referring to FIGS. 12 and 13, in a further embodiment the mounting device 14 includes a circuitous band strap 88 as described above and shown in FIGS. 10 and 11, and a cap portion 100 extending out from the band strap 88. The cap portion 100 includes one or segments 102 extending out from the band strap 88. Openings 105 are formed adjacent the segments 102 through which the sensor cable 21 can be passed. In some embodiments, the cap portion segments 102 are integrally formed with the band strap 88 (see FIG. 12). In other embodiments, the cap portion segments 102 can be attached to the band strap 88 (see FIG. 13). The segments 102 may be fixed to one another in embodiments where they overlap or intersect with each other. In either embodiment, the band strap 88 may be formed as a circuitous member or may be created from a planar strap with its lengthwise ends joined together.

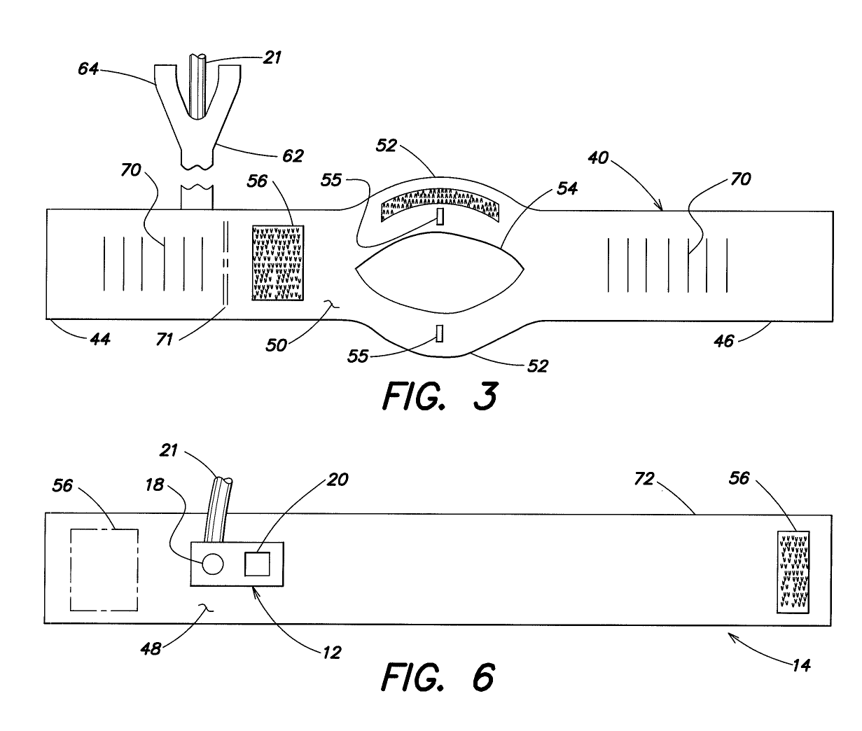

The sensor apparatus 10 may include markings 70 (e.g., see FIG. 3) disposed on the outside surface 50 of the strap 40 to facilitate alignment of the sensor(s) 12 relative to the patient by the user. For example, a centerline marking 71 may be placed on the outside surface 50 of the strap 40, which marking 71 is intended to be aligned with the middle of the patient's forehead. Aligning the centerline mark 71 with the patient's mid-forehead helps the user locate the sensor 12 relative to the patient and provides the user with greater consistency in sensor 12 application and therefore results. The outer surface of the strap 40 may also provide markings 70 that facilitate positioning multiple sensors 12 relative to the patient; e.g., sensor 12 positions for the left and right temporal regions, the left and right side skull regions, etc. The sensor apparatus may also have markings to indicate if excessive pressure is being applied to the patient from excessive tightening of the apparatus. The markings may be printed onto the material in a pattern that would visually indicate when the apparatus is stretched to a point that would exert excessive pressure onto the patient. The visual indication could be indicated by a shape change, color change, or density of pigmentation change. The indication could also be created by cutting a shape into the apparatus that would open when the apparatus is stretched.

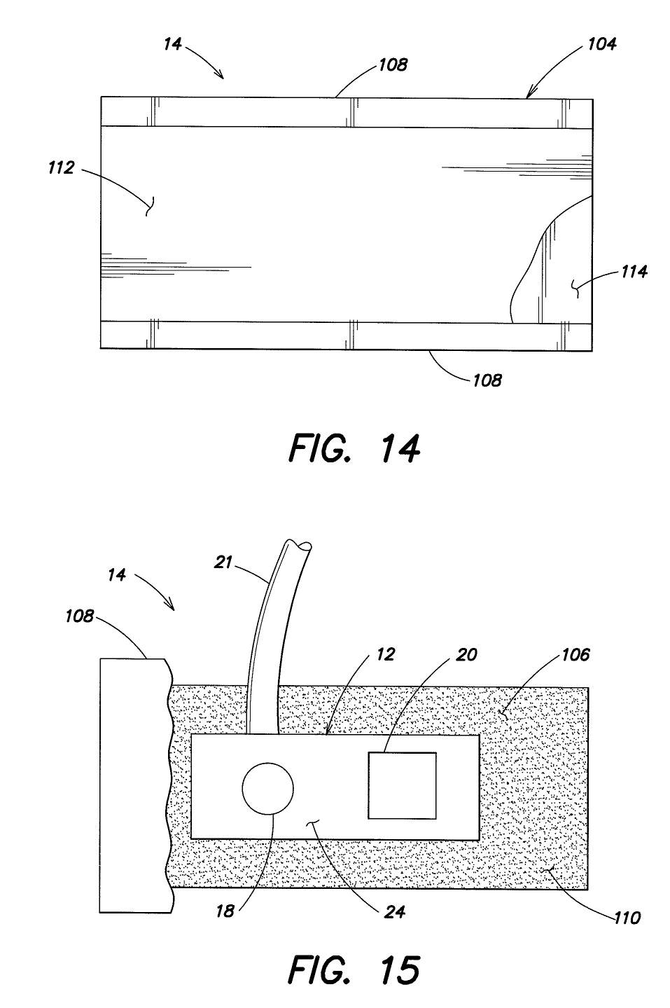

Now referring to FIGS. 14 and 15, in a further embodiment of the mounting device 14, the mounting device 14 includes a panel 104 and a removable adhesive cover sheet 108. The panel 104 has a patient side surface 110 and an outer surface 112. A layer of adhesive 106 is attached to the patient side surface 110. An example of an acceptable adhesive is a water based hydrogel adhesive, such as that used in the CAS NeoGuard® Thermal Reflector, which is manufactured and commercially sold by CAS Medical Systems, Inc. of Branford, Conn., U.S.A. The adhesive layer 106 may cover the entire patient side surface 110 of the panel 104, or it may cover a portion of the patient side surface 110. The removable adhesive cover sheet 108 (shown broken away in FIG. 15) is attached to the adhesive layer 106 until the mounting device 14 is used, at which time it can be removed to expose the adhesive layer 106. In some embodiments, the sensor 12 may be adhered to the panel 104 by the adhesive layer 106. In other embodiments, the mounting device 14 may include a sensor attachment mechanism (e.g., hook and loop fastener, snap, etc.) to attach the sensor 12 to the mounting device 14. In these type of embodiments, the sensor 12 is preferably selectively removable from the panel 104. In still other embodiments, the sensor 12 may not be attached to the mounting device 14, but rather is held in place by the mounting device 14. The panel 104 is preferably sized relative to the sensor 12 such that when the sensor 12 is attached to the panel 104 in a central location, sections of the panel 104 and the adhesive layer 106 are exposed around the periphery of the sensor 12, and can be used to attach the panel/sensor combination to the patient. The panel 104, itself, may comprise a material (e.g., Poron® foam) that substantially or completely blocks the transmission of light energy through the panel 104. In addition, or alternatively, a material 114 may be attached to the outer surface 112 of the panel 104, which material 114 is operable to act as a barrier that substantially blocks light from passing through the panel 104, which light may undesirably affect operation of the sensor 12. Examples of an acceptable material 114 that can be attached to the outer surface 112 of the panel 104 include light blocking versions of Mylar® film or Volara® foam, or other opaque film, or combinations thereof.

In use, the adhesive cover sheet 108 is removed from the adhesive layer 106 to expose the adhesive layer 106. In those embodiments where the sensor(s) 12 is attached to the panel 104, the sensor may be attached to the panel 104 (e.g., by pressing the sensor 12 into contact with the adhesive layer 106, or via a sensor attachment mechanism) before application to the patient. Because the panel 104 has a larger surface area than the sensor 12, an area of the adhesive layer 106 surrounds the periphery of the sensor 12. The mounting device 14 is then applied to the patient's head, and the exposed adhesive securely anchors the sensor 12 to the patient's skin. This method of attachment provides several distinct advantages. First, a mounting device that utilizes hydrogel as an adhesive is gentle and non-irritating when the mounting device 14 is removed from, or repositioned on the patient. Second, the adhesive layer 106 permits the mounting device 14 and sensor 12 to be repositioned/reattached several times before the mounting device 14 no longer possesses sufficient adhesion to keep the sensor affixed to the patient. Third, the mounting device 14 allows the sensor to be attached to the patient without adhesive being applied to the surface of the sensor. It is our experience that certain adhesives can function as a light shunt, allowing light to travel within the adhesive layer from the light source to the light detector. Such a light path does not travel through the patient and therefore introduces undesirable error into the sensing. The absence of an adhesive layer in contact with the operative side of the sensor in the present invention avoids undesirable shunting. Fourth, the mounting device 14 having a hydrogel or similar adhesive layer 106 can be used anywhere on the patient's body. The particular shape of the mounting device 14 can be modified to suit the application.

### NIRS Sensor Mounting Device—Abdomen Embodiments:

Now referring to FIGS. 6, 7 and 9, a further embodiment of the mounting device 14 is operable to mount one or more sensors 12 on the abdomen of a patient; e.g., a neonatal patient. The mounting device 14 may be a band 72 sized to fit around the abdomen of the patient as shown in FIG. 6. The band 72 is formed from the same type of elastically stretchable material described above. One or more sensors 12 are attached to the patient side surface 48 of the band 72, and are typically located to permit alignment with one or more internal organs of the patient; e.g., kidney, liver, etc. Details of the sensor 12 are provided above.

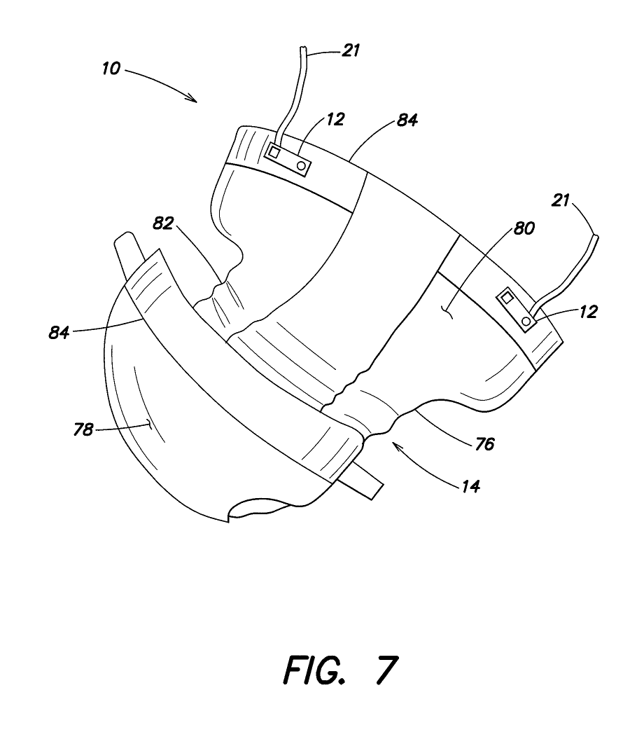

Now referring to FIG. 7, the abdomen version of the mounting device 14 may alternatively be a diaper-shaped device 76 that includes front portion 78 and a rear portion 80 connected to one another by a midsection 82 sized to fit between the legs of the patient. One or more NIRS sensors 12 may be incorporated into a waistband section 84 of the front and/or rear portions 78, 80. The waistband section 84 may comprise a material (e.g., Poron® foam) that substantially or completely blocks the transmission of light energy through the panel waistband 84. In addition, or alternatively, a material may be attached to the outer surface of the waistband 84, which material is operable to act as a barrier that substantially blocks light from passing through the waistband 84. Examples of acceptable material are provided above. In some embodiments, the diaper-shaped mounting device 76 may include functional diaper materials that enable the mounting device to provide a dual function of sensor mounting device 14 and diaper. Alternatively, the mounting device 14 may be a shell-like structure that fits over a diaper. Features (markings, hydrogel, etc.) of the mounting device 14 described above for the head mounted device 14 can be incorporated into the abdomen version.

In the operation of the present invention, the light source 18 of the NIRS sensor 12 is controlled to emit near infrared light signals of a plurality of different wavelengths. The light detector 20 is operative to measure light intensity values derived from the light emitted by the light source 18 after it has passed through the patient's body tissue.

Once the NIRS sensor 12 is positioned relative to the patient's skin, near infrared light signals are introduced into the patient's body tissue. The light resulting from the light introduced into the patient's body tissue is subsequently detected using the first and second light detectors 20, producing signals representative of such detected light. The signals are relayed back to the NIRS system via the shielded cable, where they are processed to obtain data relating to the blood oxygenation level of the patient's body tissue. As stated above, the present invention NIRS sensor assembly is not limited to use with any particular NIRS system.

Since many changes and variations of the disclosed embodiment of the invention may be made without departing from the inventive concept, it is not intended to limit the invention otherwise than as required by the appended claims.

What is claimed is:

1. A sensor apparatus, comprising:
at least one NIRS sensor having at least one light source, at least one light detector, and a flexible pad, wherein the light source and the light detector are mounted on the flexible pad, which flexible pad has a peripheral edge that extends around the entire periphery of the pad, and the light source and light detectors are configured for connection to an electro-optical cable; and
a mounting device operable to secure the sensor to a subject, which mounting device is sized to cover the sensor and contact the subject around the entire peripheral edge of the pad, and which mounting device includes a light barrier that at least substantially blocks light from passing through the mounting device.

2. The apparatus of claim 1, wherein the mounting device includes an adhesive attached to a subject contacting surface, which adhesive is operable to attach the mounting device to the subject around the periphery of the sensor.

3. The apparatus of claim 2, wherein the adhesive is a hydrogel.

4. The apparatus of claim 2, wherein the sensor is attached to the mounting device.

5. The apparatus of claim 1, wherein the mounting device is a strap having a length extending between a first end and a second end, a first side surface, a second side surface, and a means for attaching the first end and the second end to one another.

6. The apparatus of claim 5, wherein the strap is sufficiently elastic so as to apply sufficient force to hold the apparatus in place on the subject when the apparatus is mounted on the subject.

7. The apparatus of claim 5, wherein the light barrier is located on the strap to substantially align with the sensor when the first end and second end of the strap are attached to one another.

8. The apparatus of claim 7, wherein the strap further includes a midsection having a pair of segments that diverge from one another, and converge toward one another.

9. The apparatus of claim 7, wherein the mounting device further includes a top member that extends laterally outward from the strap, and includes a free end that is attachable to the strap.

10. The apparatus of claim 8, wherein the top member includes structure to secure the electro-optical cable.

11. The apparatus of claim 5, further comprising sensor alignment markings disposed on the strap.

12. The apparatus of claim 5, further comprising a region of hydrogel disposed on the first side surface.

13. The apparatus of claim 1, wherein the mounting device is a circuitous band having a first side surface, a second side surface, and a tensioning tab having a first end fixed to the band, and a second end selectively attachable to the band at a plurality of different locations on the band.

14. The apparatus of claim 13, further comprising sensor alignment markings disposed on the strap.

15. The apparatus of claim 13, wherein at least one of the band and the tensioning tab are sufficiently elastic so as to apply sufficient force to hold the apparatus in place on the subject when the apparatus is mounted on the subject.

16. The apparatus of claim 15, wherein the light barrier is located on the band to substantially align with the sensor.

17. The apparatus of claim 15, wherein the at least one NIRS sensor is attached to the band.

18. The apparatus of claim 15, wherein the mounting device further includes at least one top member having a first end attached to the band at a first position and a second end attached to the band at a second position, wherein the first position and second position are separated from one another.

19. The apparatus of claim 15, wherein at least one of the top members includes structure to secure the electro-optical cable.

20. The apparatus of claim 1, wherein the mounting device includes a front portion, a back portion, and a midsection extending between the front and mid portions, wherein the front portion and the back portion each include a pair of end regions operable to attach to the end regions of the other portion, and which portions include a waistband portion having a length, and the midsection has a length which is less than the length of either waistband region, and the at least one NIRS sensor is attached to the waistband portion.

21. The apparatus of claim 1, further comprising an electro-optical cable connected to the sensor, which electro-optical cable includes at least one fiber optic light guide and at least one electrical cable disposed within a sheath that has a cross-sectional geometry that is constant in a lengthwise direction.

22 The apparatus of claim 21, wherein the electro-optical cable has a pair of electrical cables and the fiber optic light guide is disposed between the electrical cables.
